(19) United States
(12) Patent Application Publication
(10) Pub. No.: US 2011/0223312 A1
(43) Pub. Date: Sep. 15, 2011

(54) TRIGLYCERIDE-ENCAPSULATED PHYTOSTEROL MICROPARTICLES DISPERSED IN BEVERAGES

(76) Inventor: Daniel Perlman, Arlington, MA (US)

(21) Appl. No.: 12/627,466

(22) Filed: Nov. 30, 2009

(51) Int. Cl. A23D 7/005; A23D 9/007

(52) U.S. Cl. 426/611

(57) ABSTRACT

A method of supplementing a beverage or other edible aqueous medium with phytosterols, and the resulting phytosterol-supplemented edible media and other edible products, are described. The method includes admixing a dry powder of non-esterified phytosterol microparticles with triglyceride-based edible oil to produce a slurry of powder in oil. The slurry is optionally homogenized to disaggregate caked or otherwise aggregated phytosterol microparticles, allowing an increased proportion of the microparticles to be uniformly coated with the oil. The slurry is admixed and homogenized in the liquid aqueous phase of an edible aqueous medium with at least one exogenous emulsifier, surfactant or other agent that can stabilize the dispersion of oil-encapsulated phytosterol microparticles. The beverage or other edible aqueous medium may be pasteurized.

### RELATED APPLICATIONS

Not Applicable.

### FIELD OF THE INVENTION

The present invention relates to a beverage composition containing phytosterols in which the bioavailability of dispersed phytosterols for combining with cholesterol in the GI tract is improved by introducing phytosterol microparticles that are fat-encapsulated within a slurry. The slurry is dispersed in an aqueous medium together with an exogenous fat emulsifier or other fat dispersing agent, for example a beverage such as soy milk or cows milk that contain fat-emulsifying proteins and/or other fat emulsifiers.

### BACKGROUND OF THE INVENTION

The following discussion is provided solely to assist the understanding of the reader, and does not constitute an admission that any of the information discussed or references cited, constitute prior art to the present invention.

This invention concerns particles of plant sterols, i.e., phytosterols that do not easily disperse in aqueous environments without some modification. With appropriate modification, phytosterol particles can be dispersed in aqueous foods and beverages or used in dietary supplements. When mixed with cholesterol in the gastrointestinal tract, these phytosterols can help reduce the LDL cholesterol level in the bloodstream. The present invention also relates to the surprisingly improved bioavailability of modified phytosterol microparticles provided in the mammalian diet, resulting in a substantial decrease in plasma LDL cholesterol levels.

Previous inventors have gone to considerable lengths to formulate aqueous suspensions from water-insoluble phytosterols, and to create novel phytosterol particle chemistries in which either the outside surface, or the entire composition of the dry particles has been chemically modified to allow dispersal of the particles in water. These phytosterol particle modifications have generally involved relatively costly liquid processing steps, e.g., solution or suspension processing, spray-drying, melt-processing, and the like.

Over thirty years ago, Thakkar et al. in U.S. Pat. No. 3,881,005 stated the following: “In order for sitosterols to be effective in lowering serum cholesterol, the medicament must reach the gastrointestinal tract in a finely divided dispersed state. Because of the hydrophobic character of sitosterols, it has not been possible to prepare a conventional tablet or capsule which will allow the thorough dispersion of the medicament in the G.I. tract. In addition, the wax-like hydrophobic surface of sitosterols makes the dispersion of the active agent in water a most difficult task. Providing a packet of finely ground sitosterols to be dispersed in water immediately before administration has not been heretofore been feasible.”

Thakkar et al. describe a complicated preparation of a pharmaceutical water-dispersible sitosterol powder. Their powder is prepared using sitosterols, an excipient or combination of excipients (such as starch, starch hydrolysate, and fumed silicon dioxide), a non-ionic or anionic surfactant (such as polyoxyethylene (20) sorbitan monostearate or sodium lauryl sulfate) and water. The surfactant is dispersed in water, the excipients are added to the surfactant-containing water, the sitosterols are added, the mixture is homogenized, deaerated, pasteurized, and the mixture is spray-dried. The resulting sitosterols that have been coated in an aqueous medium with excipient materials and surfactant are then dried, and are water-dispersible.

Ong in U.S. Pat. No. 4,195,084 describes an aqueous pharmaceutical suspension of sitosterols that includes finely divided tall oil sitosterols, a chelating agent to prevent oxidation of sitosterols, sodium carboxymethylcellulose, sorbitol, a surfactant (such as polyoxyethylene (20) sorbitan monostearate or sodium lauryl sulfate), simethicone and water. A rather complex series of steps is utilized in combining these various ingredients to produce the pharmaceutical suspension.

In recent years, researchers at McNeil-PPC, Inc. have authored a series of patents describing water-dispersible sterols. For example, Burruano et al. in U.S. Pat. Nos. 6,054,144 and 6,110,502 describe a method for preparing sterols in a stable powder matrix that is self-emulsifying upon addition to food. A water-dispersible β-sitosterol or oryzanol powder is produced by forming a suspension of either of these sterols in an aqueous mixture of both a monofunctional surfactant (hydrophobic) and a polyfunctional surfactant (hydrophilic), and subsequently drying, e.g., spray-drying, the suspension to produce a water-dispersible powder form of the sterol. Tween 40 [polyoxyethylene (20) sorbitan monopalmitate, a liquid] is the preferred monofunctional surfactant (defined as bonding to the sterol), and is used in an approximate 1:1 ratio with Span 80 (sorbitan monooleate, a solid), the preferred polyfunctional surfactant (defined as bonding to the sterol and the other surfactant).

In U.S. Pat. Nos. 6,242,001 and 6,387,411 Bruce et al. describe a solid composition that includes a sterol/stanol or an ester thereof and any of a variety of hydrocarbon materials, and that is free of water. The ingredients are combined, e.g., via melting, and the resulting solids are ground to form small dispersible particles. The invention of Bruce et al. claims to minimize the incorporation of surfactants and dispersants and, with the added hydrocarbons, avoids formation of an aqueous particle suspension that would require an expensive drying step, e.g., spray-drying, before obtaining a dispersible powder.

Stevens et al., U.S. Pat. No. 6,623,780 describes a composition that includes one part sterol, 1.14-1.5 parts monoglyceride and 0.04-0.20 parts polysorbate (e.g., Tween 60, polyoxyethylene (20) sorbitan monostearate), that are melted together and spray-microprilled to form a powder in which 90% of the particles in water are smaller than one micron. The invention also describes heating a suspension of these particles in an aqueous food or beverage to above the melting temperature of the particles, and shearing the mixture.

Ostlund, Jr., U.S. Pat. No. 5,932,562 describes an aqueous micellar mixture of plant sterol and lecithin (in a 1:1 to 1:10 mole ratio) which has been dried to a water soluble powder and which is useful as a food additive for reducing cholesterol absorption. The description points out that cholesterol is absorbed from an intestinal micellar phase containing bile salts and phospholipids which is in equilibrium with an oil phase inside the intestine. Prior to recent experiments, delivery of phytosterol as a solid powder or aqueous suspension was thought to not be preferred because of the limited rate and extent of solubility in intestinal liquid phases. In fact, at least two earlier human studies showed that as much as 9-18 grams of sitosterol per day were required to decrease the plasma cholesterol level by approximately 15% when the sitosterol was provided in a coarse powdered (rather than soluble) form. Yet, esterification of phytosterols, coupled with the use of edible oils to deliver these sterols is not always practical, e.g., in formulating fat-free foods. It is in this context that Ostlund, Jr. provides a water-dispersible mixture of plant sterol and lecithin.

Ostlund, Jr., U.S. Pat. No. 6,063,776, describes a water-soluble powder that includes an aqueous homogeneous micellar mix of plant sterol and salt of lactic acid coupled to a fatty acid, such as sodium stearoyl lactylate, in which the mixture has been water-emulsified and dried to a soluble powder.

In U.S. Pat. No. 6,677,327 Gottemoller describes an edible composition that includes plant sterols/stanols, a water-soluble or dispersible protein such as whey, soy, gluten or caseinate protein, and also lecithin, in which the composition is free of oil and has been dried to a water dispersible powder.

Other investigators have believed that to obtain appreciable benefit from phytosterols [by definition herein, including plant sterols, stanols, or combinations thereof, including beta-sitosterol, beta-sitostanol, campesterol, campestanol, stigmasterol, stigmastanol, brassicasterol, brassicastanol, clionasterol and clionastanol (collectively termed phytosterol or phytosterols)] for lowering plasma cholesterol, the phytosterol should be dissolved in an edible oil or other solvent so that it can enter micelles in the small intestine to inhibit the absorption of cholesterol. This belief was supported by early research carried out in the 1950s through the 1970s showing that large doses of phytosterols in their solid form, i.e., coarse particles, were required to achieve meaningful decreases in plasma cholesterol levels. For example, in 1956, Faquhar et al., (Circulation, 14, 77-82, 1956) showed that doses of 12-18 g per day of beta sitosterol (provided in divided doses) were required to achieve a 15-20% lowering of serum cholesterol in males with atherosclerosis. In another study, 9 g per day (3 g t.i.d.) of soybean-derived phytosterols were required to lower plasma cholesterol approximately 9% (Kucchodkar et al., Atherosclerosis 23:239-248, 1976). In yet another study, 3-9 g per day of tall oil-derived phytosterols was required to lower plasma cholesterol approximately 12% (Lees et al., Atherosclerosis 28:325-333, 1977). In a recent study, 1.7 g per day of finely powdered tall oil-derived phytosterols were sufficient to lower total plasma cholesterol by 9% and LDL-cholesterol by about 15% (Jones et al., Am. J. Clin. Nutr. 69: 1144-1150, 1999).

It has been generally appreciated that phytosterols such as alpha- and beta-sitosterol, stigmosterol, campesterol and others, including the corresponding saturated (chemically reduced or hydrogenated) “stanol” species, are insoluble in water, and only slightly soluble in edible oils. Accordingly, to promote the solubilization of phytosterols, and their efficacy in lowering plasma cholesterol, U.S. Pat. No. 6,025,348 by Goto et al. describes the incorporation of at least 15% and as much as 70% by weight or more of a polyhydric alcohol/fatty acid ester (including glycerol fatty acid esters containing at least two esterified and at least one unesterified hydroxyl group such as diacylglycerols or diglycerides), into a fat. Between 1.2% and 4.7% by weight of phytosterol is incorporated into the polyhydric alcohol/fatty acid ester containing fat composition. Additionally, U.S. Pat. No. 6,139,897 by Goto et al. describes an oil or fat composition containing 80% or more diacylglycerol and up to 20% phytosterol. The high proportion of diacylglycerol assures solubility or dispersal of the phytosterol to provide a cholesterol-lowering fat substitute.

Perlman et al. in U.S. Pat. Nos. 6,638,547 and 7,144595 describe prepared food products that include a fat-based composition with phytosterols that are substantially free of exogenous solubilizing and dispersing agents. Between 75% and 98% by weight of edible fat or oil are heated to dissolve between 2% and 25% by weight of non-esterified phytosterols. The phytosterol-fat solution is exposed to oxidizing conditions during heating and/or food product preparation. Crystallization and formation of TRPs (triglyceride-recrystallized phytosterols) occur during cooling. Perlman et al. in U.S. Pat. No. 7,575,768 describe dietary supplements and prepared foods in which this technology is extended to include the combination of between 25% and 75% by weight of one or more triglyceride-based edible oils or fats and between 25% and 75% by weight of one or more non-esterified phytosterols that have been converted to TRPs by heating and cooling.

U.S. Pat. No. 5,998,396 by Nakano et al., describes an edible oil containing a phytosterol, vitamin E, and an emulsifier rendering the phytosterol soluble in both the vitamin E and the edible oil.

U.S. Pat. No. 5,419,925 by Seiden et al. describes a reduced calorie fat composition based upon a substantially non-digestible polyol fatty acid polyester plus reduced calorie medium chain triglycerides and other reduced calorie fats or noncaloric fat replacements including plant sterol esters that are soluble in such fat compositions. Free fatty acids, vitamin E and tocotrienol have each been utilized by other inventors to promote the solubilization of phytosterols in fats and oils, with the expectation that the cholesterol lowering properties of various phytosterols would be improved.

U.S. Pat. No. 5,244,887 by Straub describes the preparation of a cholesterol-lowering food additive composition with plant stanols, including: (i) an edible carrier such as an oil, monoglyceride, diglyceride, triglyceride, tocopherol, alcohol or polyol, (ii) an antioxidant and (iii) a dispersant or detergent-like material such as lecithin, or other phospholipids, sodium lauryl sulfate, a fatty acid, salts of fatty acids, or a fatty acid ester. Straub cites research showing that 1.5 grams per day of a stanol mixture derived from soybean sterols lowered blood cholesterol by 15% after 4 weeks of therapy, and believes that these stanols are preferred to sterols based upon less stanol absorption from the G.I. tract and better heat stability in air than sterols.

Akashe et al., U.S. Pat. No. 6,267,963 describes a plant sterol/emulsifier complex that has a lower melting temperature than the plant sterol alone. The complex, e.g., a co-crystallized monoglyceride and plant sterol mixture, either with or without triglyceride oil, is said to facilitate incorporation of the sterol into food products without adversely affecting the texture of the food products.

As indicated above, it has been widely believed that increasing the solubility of phytosterols in fat increases their bioavailability and reduces the dose required to achieve a specified degree of cholesterol reduction. Thus, U.S. Pat. No. 5,502,045 by Miettinen et al. describes the preparation and use of the plant stanol, beta sitostanol, in the form of a fatty acid ester which is readily soluble in an edible oil, to reduce the serum cholesterol level in humans. This technology has been utilized in manufacturing the margarine product marketed under the tradename Benecol®.

U.S. Pat. Nos. 6,031,118 and 6,106,886 by van Amerongen et al. describe similar stanol fatty acid esters but provide different and reportedly improved chemical methods for their preparation. Plant sterols (from soybean oil) have also been interesterified with fatty acid esters to produce the margarine marketed under the tradename Take Control®. Clinical studies suggest that with mildly hypercholesterolemic individuals, dietary intake of between 1.5 and 3 grams per day of such phytosterols provided in a fatty acid esterified form is required to decrease plasma cholesterol approximately 15%.

Thorough dispersal of free phytosterol microparticles in a food or beverage may not be sufficient to render the particles fully bioavailable for reducing plasma levels of LDL cholesterol. For example, a recently commercialized product containing free phytosterols and marketed in the U.S. as “Heart Healthy” soy milk (Silk brand) claims that the product provides a 7% reduction in plasma LDL cholesterol if 3 servings of the product (containing a total of 2.0 g of free phytosterols) are consumed daily. It is believed that substantially greater reductions in plasma LDL levels should be expected from these dosages of phytosterols. A review article entitled “Therapeutic potential of plant sterols and stanols” (Plat et al., Current Opinion in Lipidology, 11: 571-576, 2000) has summarized the results of a number of independent clinical studies in which human plasma cholesterol levels were monitored before and after ingestion of food products enriched with plant sterols and sterol esters (approximately 2-2.5 g per day). The authors conclude that LDL cholesterol levels can be decreased significantly, i.e., an average of 10-14%, with such dosages.

Another method of producing a fine suspension of microparticulate phytosterols in fat and water has been described by Yliruusi, et al. in U.S. Pat. No. 6,531,463. The method involves first heating and dissolving beta-sitosterol in a fat or oil, and then precipitating the phytosterol with water to form a microcrystalline suspension of phytosterol particles in a mixture of water and fat. The beta-sitosterol and food grade oil are mixed, and this mixture is heated until all solids are dissolved in oil. After cooling, water is added into the mixture at the temperature thereof, thereby dispersing it. The result is a homogeneous fat-like mass with a consistency closely resembling that of butter, or an oily mixture, depending on the amounts of the components.

In summary, the production of physically and/or chemically modified phytosterol microparticles is described extensively in the prior art literature. These modifications may involve substantial cost and inconvenience, and may result in products that are less stable or less effective than the original phytosterol ingredient. Phytosterol modification may involve grinding, spray-drying, mixed emulsion formation, chemical modification such as esterification, and/or combining with substantial amounts of specialized solubilizing and dispersing agents.

### SUMMARY OF THE INVENTION

This invention concerns cholesterol-reducing edible aqueous compositions, often liquid aqueous media such as beverage compositions, in which free (non-esterified) phytosterol microparticles and triglyceride oils are combined and dispersed as new microparticles in a bioavailable form. Bioavailability of the phytosterol microparticles for mixing with cholesterol in the GI tract is enhanced by encapsulating the phytosterol microparticles in a fat, e.g., an oleic acid-rich sunflower vegetable oil. The oil-encapsulated phytosterol microparticles are advantageously formed by making a slurry of phytosterol microparticles in vegetable oil and homogenizing the slurry in an aqueous medium. In the presence of an exogenous dispersing agent, these oil-encapsulated phytosterol microparticles (OEPMs) are dispersed in the beverage composition or other edible aqueous medium. Surprisingly, microscopic examination shows that most of the oil encapsulation coating remains attached to the phytosterol microparticles in the emulsifying medium. The aqueous dispersion can be subjected to heat-pasteurization with little or no exposure to air or oxidizing conditions.

In most cases, the initial proportion of oil included in the slurry is equal to or greater than the amount of phytosterol material, i.e., the weight ratio is commonly 1-10 parts of oil per part of phytosterol. Preferably, this weight ratio is 2-5, and for a number of applications, e.g., beverage applications, a ratio of approximately 3 has been found advantageous. In other embodiments, the ratio is 1-5 or 5-10. Vegetable oil-derived and tall oil-derived phytosterol microparticles have been utilized. Providing a sufficient ratio of oil to phytosterol helps assure a sufficient amount of oil for encapsulating the microparticles while also limiting the dynamic viscosity of the slurry. This facilitates slurry flow during food production.

The slurry is dispersed in beverages or other edible aqueous medium such that oil-encapsulated phytosterol microparticles or microdroplets (OEPMs) are formed in the presence of exogenous emulsifier or surfactant or other exogenous dispersing agent which allows and maintains dispersal of the OEPMs in the beverage or other aqueous medium. In some advantageous applications, the base aqueous medium (e.g., base beverage) contains either natural or synthetic (or both) emulsifiers, surfactants, and/or dispersing agents. For example, soymilk and cows milk contain fat-emulsifying and phytosterol-emulsifying proteins as well as other substances that help disperse a slurry containing vegetable oil and phytosterol microparticles. The slurry is useful, for example, as a beverage additive, a food additive, or a dietary supplement ingredient, and allows processed food manufacturers to cost-effectively disperse phytosterols as well as other fat-soluble micronutrients. These micronutrients may include omega-3 enriching oils such as fish oil, flaxseed oil, fat-soluble vitamins such as vitamins A, D, E and K and various antioxidants in water-containing foods and beverages such as yoghurts, soups, sauces, coffee, juices, milk, milk-containing breakfast cereals, soy milk and the like.

Subsequent to forming the slurry, it is dispersed into an edible aqueous medium such as a beverage using high shear (i.e., homogenizing) that produces fatty microdroplets. Commonly the fatty microdroplets are of an average size that is sufficient to encapsulate one or more phytosterol microparticles (e.g., a median diameter of approximately 0.5-50 microns). The fatty microdroplets must be stabilized against coalescing into a continuous oil phase within the beverage; this is accomplished by supplying one or more emulsifiers, surfactants, or other dispersants which are exogenous to the phytosterol and oil and which are effective to stabilize the dispersed fatty microdroplets in the aqueous medium. In certain advantageous cases as noted above, a beverage such as cows' milk or soy milk or other aqueous liquid is selected to provide the exogenous emulsifier. That is, a beverage or other aqueous liquid is used which contains naturally occurring fat-emulsifying proteins such as casein, and/or other fat emulsifiers such as lecithin, a phospholipid. Alternatively or in addition, to prevent oil separation, a natural emulsifier such as lecithin or a synthetic emulsifier such as a monoglyceride or a polysorbate species may be selected and added to the slurry and/or an aqueous composition that lacks adequate amounts of natural and/or synthetic emulsifiers of fats and oils.

The present slurries are simple to assemble and are useful because they allow processed food and beverage producers as well as dietary supplement manufacturers to cost-effectively disperse phytosterols as well as other fat-soluble micronutrients. These micronutrients include omega-3 enriching oils such as fish oil, fat-soluble vitamins such as vitamins A, D, E and K and various antioxidants in water-containing foods and beverages such as yoghurts, soups, sauces, coffee, juices, milk, milk-containing breakfast cereals, soy milk, and the like.

Thus, a first aspect of the invention concerns a method of supplementing an edible aqueous medium (e.g., a beverage) with phytosterols by homogenizing a suspension of oil and phytosterols in aqueous medium, thereby producing a phytosterol-supplemented aqueous medium which has a stable dispersion of oil-encapsulated phytosterol microparticles (OEPMs) in aqueous medium, in which the phytosterol-supplemented aqueous medium contains at least one exogenous emulsifier, surfactant and/or other dispersing agent that stabilizes the dispersion of the oil-encapsulated phytosterol microparticles in the phytosterol-supplemented aqueous medium. The method will also most often include combining a slurry of non-esterified phytosterol microparticles dispersed in edible oil with an aqueous medium (i.e., a base aqueous medium) to produce the suspension of oil and phytosterol in aqueous medium

In some embodiments, the method also includes admixing the phytosterols, in the form of a microparticulate dry powder, with a triglyceride-based edible oil to produce the slurry, and can also include homogenizing the slurry to disaggregate caked or otherwise aggregated phytosterol microparticles, allowing an increased proportion of the phytosterol microparticles to be coated with the oil.

In particular embodiments, one part by weight of the phytosterols is admixed with at least one part by weight of the triglyceride-based edible oil, e.g., 1 part phytosterols are admixed with 1-100, preferably 1-50, 1-30, 1-20, or 1-10 parts edible oil, or 1 part phytosterols are admixed with 1-5 parts edible oil or 1 part phytosterols are admixed with 5-10 parts edible oil, or 1 part by weight of phytosterols are admixed with 2-5, 2-4, or 2-3 parts by weight of triglyceride-based edible oil.

In some embodiments, the method also includes pasteurizing the phytosterol-supplemented aqueous medium or the suspension of oil and phytosterols in aqueous medium, e.g., with one of the varieties of heat pasteurization (e.g., as indicated in the Detailed Description below) or with a method of cold pasteurization. Preferably heat pasteurization is carried out in a closed system that substantially excludes air, thereby preventing oxidation of said oil and development of off-flavors.

In particular embodiments, the phytosterol-supplemented aqueous medium is a beverage, usually a commercial beverage, e.g., a milk such a dairy milk (such as cows milk, goat milk, and the like) or soy milk, or a fermented dairy beverage; the phytosterol-supplemented aqueous medium is an aqueous fluid component of, or aqueous precursor to, a processed food product.

A variety of different phytosterols and phytosterol microparticles may be used; thus in various embodiments, the phytosterols are purified from a tall oil or a vegetable oil; the phytosterols include beta-sitosterol and optionally other plant sterols; the phytosterols comprise beta-sitostanol and optionally other plant stanols; the weight average diameter of the phytosterol microparticles (i.e., non-ester phytosterol microparticles) used to form the oil slurry composition is not greater than 50, 40, 30, 25, 20, 15, 12, 10, or 8 microns, or is in a range of 1-25, 1-20, 1-15, 1-10, 3-25, 3-20, 3-15, 3-10, 5-25, 5-20, 5-15, or 5-10 microns; at least 90% by weight of the phytosterol microparticles have a diameter of equal to or less than 100, 80, 70, 60, 50, 40, 30, 25, 20, 15, 12, 10, or 8 microns; at least 50% by weight of the phytosterol microparticles have a diameter of equal to or less than 50, 40, 30, 25, 20, 15, 10, or 8 microns; the solid form of the phytosterols is selected from the group consisting of regular-shaped (e.g., approximately spherical or rod-shaped) and irregular-shaped microparticulate powders, that are capable of being easily dispersed in a triglyceride-based oil or fat of vegetable or animal origin (collectively referred to herein as “oil”) upon mixing, blending or homogenizing either with or without moderate warming, e.g., incubation at 25-65° C., 40-50° C., 40-65° C., forming a slurry; an anticaking agent is added to the phytosterols which improves the dispersibility of the phytosterols in the edible oil.

Various oils can also be used; thus in certain embodiments, the oil is vegetable oil, fish oil, algae oil, animal fat, or any combination of 2, 3, or 4 of the identified oils/fats; the triglyceride-based edible oil is corn oil, soybean oil, canola oil, safflower oil, sunflower oil, high oleic sunflower oil, high oleic safflower oil, or a combination of any 2, 3, 4, 5, 6, or 7 of the identified oils; the triglyceride-based edible oil includes an omega-3 fatty acid enriching oil such as a fish oil, algae oil, flaxseed oil, or combination thereof; the triglyceride-based edible oil also includes at least one oil-soluble micronutrient, such as oil-soluble vitamins, oil-soluble antioxidants, omega-3 fatty acid enriching oils, and combinations thereof; the triglyceride-based edible oil also includes at least one oil-soluble micronutrient such as vitamin A, vitamin D, vitamin E, vitamin K, fish oil, algae oil, flaxseed oil, and combinations thereof.

In particular embodiments, the base aqueous medium contains at least one emulsifier, surfactant or other dispersing agent that stabilizes the dispersion of the microparticles in the phytosterol-supplemented aqueous medium; at least one emulsifier, surfactant or other dispersing agent that stabilizes the dispersion of said microparticles in the phytosterol-supplemented aqueous medium is added to the base aqueous medium; at least one emulsifier, surfactant or other dispersing agent that stabilizes the dispersion of the microparticles in the phytosterol-supplemented aqueous medium is added to the slurry; at least one emulsifier, surfactant or other dispersing agent that stabilizes the dispersion of the microparticles in the phytosterol-supplemented aqueous medium is present as a natural component of the base aqueous medium; the base aqueous medium is cows milk and the emulsifier includes a casein protein; the base aqueous medium is a soy milk and the emulsifier includes soy lecithin; the exogenous emulsifier, surfactant or dispersing agent(s) includes at least one non-ionic component and at least one ionic component in either separate molecular species, or in a single molecular species as a “binary surfactant”; an ionic surfactant is selected from the group consisting of anionic surfactants, cationic surfactants and zwitterionic surfactants; the non-ionic surfactant is selected from the group consisting of monoglycerides and combinations of mono-and diglycerides, with or without one or more ionic surfactants, e.g., stearic acid; the included binary surfactant includes at least one non-ionic surfactant and at least one ionic surfactant.

Also in certain embodiments, from 0.1 to 20, 0.1 to 10, 0.1 to 5, 0.2 to 10, 0.2 to 5, 0.2 to 2, 0.5 to 20, or 0.5 to 10, or 0.5 to 5 parts by weight of the slurry is added to 100 parts by weigh of the base aqueous medium; the phytosterol-supplemented aqueous medium is a food product and sufficient slurry is combined with the aqueous base suspension to provide at least 400, 500, 600, 700, or 800 mg of phytosterols per serving of the food product.

For some embodiments, the edible oil is in a temperature range from normal ambient to elevated, e.g., the edible oil is at a temperature of 20 to 65° C., 25 to 65° C., 25 to 60° C., 25 to 55° C., 25 to 50° C., 25 to 45° C., 35 to 65° C., 35 to 60° C., 35 to 50° C., or 40 to 60° C. during mixing of the non-esterified phytosterols with the edible oil.

Likewise, in certain embodiments, the base aqueous medium (or both the base aqueous medium and the slurry) is in a temperature range from ambient to elevated, e.g., 20 to 65° C., 25 to 65° C., 25 to 60° C., 25 to 55° C., 25 to 50° C., 25 to 45° C., 35 to 65° C., 35 to 60° C., 35 to 50° C., or 40 to 60° C.

In advantageous embodiments, at least a substantial fraction, most, or substantially all (i.e., each) phytosterol microparticles in the phytosterol-supplemented aqueous medium has at least a partial encapsulation coating of the edible oil; at least 50, 60, 70, 80, 90, 95, 98, or 99% of the phytosterol microparticles in the phytosterol-supplemented aqueous medium has at least a partial encapsulation coating of the edible oil; at least 50, 60, 70, 80, 90, 95, 98, or 99% of the phytosterol microparticles in the phytosterol-supplemented aqueous medium has an encapsulation coating of the edible oil covering at least 50, 60, 70, 80, or 90% of the surface area of the microparticle; at least 50, 60, 70, 80, or 90% of the phytosterol microparticles are fully encapsulated with the edible oil.

In further embodiments, the oil-encapsulated phytosterol microparticles have a median diameter in the range of 2-200, 5-150, 10-150, 10-100, 10-50, 25-200, 25-100, 25-75, 25-50, 50-200, 50-100, or 50-75 microns; the oil-encapsulated phytosterol microparticles have a median density or a weight average which is less than the density of the base aqueous medium and greater than the edible oil; the oil-encapsulated phytosterol microparticles have a median density or weight average density which is less than cows milk and greater than vegetable oil; the oil-encapsulated phytosterol microparticles have a median density or weight average density which is less than soy milk and greater than vegetable oil; the oil-encapsulated phytosterol microparticles have a median or the weight average density at 20 degrees C. in a range of 0.925 to 1.025 g/cm³, 0.930 to 1.025 g/cm³, 0.940 to 1.025 g/cm³, 0.950 to 1.025 g/cm³, 0.960 to 1.025 g/cm³, 0.970 to 1.025 g/cm³, 0.980 to 1.025 g/cm³, 0.990 to 1.025 g/cm³, 1.000 to 1.025 g/cm³, 0.925 to 1.000 g/cm³, or 0.950 to 1.000 g/cm³; the median or the weight average density of the oil-encapsulated phytosterol microparticles is within 10, 9, 8, 7, 6, 5, 4, 3, 2, or 1% of the density of the base edible aqueous medium (e.g., cows milk or soy milk) at 20 degrees C.

In various embodiments, the aqueous medium is part of a composition which at normal storage temperature (or at 20 degrees C. if no normal storage temperature is applicable) is liquid, flowable, or semi-solid.

A related aspect concerns a method for forming a slurry of microparticulate phytosterols in edible oil by admixing one part by weight of dry microparticulate phytosterols with 1-20, 1-10, 1-7, 1-5, 2-10, 2-7, 2-5, or 2-4 parts by weight of edible oil.

In particular embodiments, the phytosterols, edible oil, additional slurry components, and/or conditions or methods of admixing are as described for the first aspect above or otherwise described herein for forming the phytosterol/oil slurry.

Another related aspect of the invention concerns a phytosterol slurry composition which results from the blending, and optionally homogenizing, one part by weight of phytosterol microparticles with between one part and one hundred parts of an oil, or other ratio of phytosterol and oil as specified in the first aspect above.

In particular embodiments, the phytosterols, edible oil, and/or additional slurry components are as described for the first aspect above or otherwise described herein for the phytosterol/oil slurry.

In preferred embodiments, the slurry composition is dispersible via homogenization in hot aqueous media and/or cold aqueous media, e.g., in cold beverages and/or hot beverages.

Another related aspect concerns a phytosterol-supplemented edible aqueous medium, for example, a beverage. The medium includes a dispersion of oil-encapsulated phytosterol microparticles, where the phytosterols are non-esterified phytosterols and the dispersion is assisted by the presence of one or more exogenous emulsifiers, surfactants, or other dispersing agents.

In particular embodiments, the phytosterol microparticle component, edible oil component, additional oil-soluble components, component ratios, microparticle size range, and/or composition are as described for the first aspect above; the phytosterol-supplemented edible aqueous medium is a medium resulting from a method of the first aspect above or as otherwise described herein for the invention.

In certain embodiments, the phytosterol-supplemented aqueous medium is homogenized; the phytosterol-supplemented aqueous medium is homogenized and is pasteurized, either before or after homogenization.

The present invention also provides methods for using the present phytosterol-containing slurries and the resulting phytosterol-supplemented aqueous media, e.g., beverages, and processed foods containing such phytosterol-supplemented aqueous media. Such methods include use of such compositions in the diet of individuals and/or in preparing foods or beverages by incorporating the slurry compositions in an edible food or beverage, preferably by homogenizing the slurry in an aqueous medium with exogenous surfactant, emulsifier, and/or other dispersing agent such that a stable dispersal of OEPMs in the aqueous medium is provided.

Thus, for example, another aspect concerns a method for supplementing the diet of an individual with phytosterols by adding an amount of an oil slurry containing microparticulate phytosterols to a food or beverage item (usually the food or beverage item is or contains an aqueous medium), and can further include an individual ingesting at least a portion of the food item or beverage. As indicated, highly preferably the slurry is homogenized in an aqueous medium with exogenous surfactant, emulsifier, and/or other dispersing agent such that a stable dispersal of OEPMs in the aqueous medium is provided in the food item or component thereof.

In particular embodiments, the amount of microparticulate phytosterols and oil slurries containing these phytosterols included in a single serving of the food item or beverage is an amount which does not significantly change the taste, texture, and/or mouth feel of the food item or beverage, and/or the amount is a cholesterol-lowering amount; the food item or beverage is yoghurt, soup, sauce, coffee, juice, soy milk, cows milk a milk-containing breakfast cereal, mashed potatoes, refried beans, pasta, or rice.

In particular embodiments of this aspect or any embodiment thereof, the composition is a composition as described for an aspect above, or otherwise described herein for the present invention.

Another aspect concerns a method for reducing a person's uptake of dietary cholesterol by ingesting a cholesterol lowering amount of the present compositions, e.g., as a beverage and/or in other foods.

In particular embodiments, the microparticulate phytosterol-containing oil slurry composition and/or the phytosterol-supplemented beverage or other edible aqueous medium is as described for an aspect above or otherwise described herein.

Also in particular embodiments, the composition is ingested as part of a food or beverage item of a type indicated herein, e.g., water, juice, coffee, milk, yoghurt, liquid dietary supplement, cereal and milk, sauce, soup, mashed potatoes, hydrated beans, boiled pasta, boiled rice, and other such water containing foods and beverages.

In particular embodiments the person has elevated cholesterol levels prior to ingesting the present compositions; daily ingestion of the present compositions providing at least 400, 500, 600, 700, or 800 mg of phytosterols per serving of a food or beverage item, and preferably providing a total dietary intake of at least 600, 700, 800, 900, or 1000 mg of phytosterols per day, reduces serum cholesterol levels of normal individuals by at least 3, 5, 7, 10, 12, or 15%.

Additional embodiments will be apparent from the Detailed Description and from the claims.

### DETAILED DESCRIPTION OF THE PREFERRED EMBODIMENTS

### General Description

This invention relates to methods and compositions for supplementing an edible aqueous medium, such as a beverage, with non-esterified phytosterols. Applicant has discovered a novel method for dispersing non-esterified phytosterol microparticles in aqueous compositions. The method involves encapsulating the phytosterols, commonly as individual or groups of phytosterol microparticles, with a triglyceride-based fat or vegetable oil (interchangeably herein termed “fat” or “oil”), in which the resulting fat-encapsulated particles are conveniently dispersed in a fat-emulsifying/stabilizing aqueous medium, commonly a beverage such as cows milk or soy milk. The slurry method is simpler and less costly to use than many existing methods used for manufacturing beverage-dispersible phytosterol particles described in the prior art. Applicant further finds that the fat-encapsulated microparticles often require only the emulsifiers already found in existing beverages, e.g., soymilk and cows milk, for establishing and maintaining stable microparticle dispersal. Maintenance of the dispersion is also facilitated because, in contrast to the initial phytosterol microparticles, the oil-encapsulated phytosterol microparticles have densities close to the density of the aqueous medium; in most cases the density of the oil-encapsulated phytosterol microparticles is slightly less than the density of water.

As indicated, the method and process essentially involves admixing, i.e., combining and blending together the non-esterified phytosterol microparticles with an edible oil, generally one part by weight of non-esterified phytosterols (including phytosterols and/or phytostanols in the form of a microparticulate dry powder), and at least one part by weight of a triglyceride-based edible oil (including single oils, blends of multiple oils and fats of vegetable and/or animal origin that may be liquid or solid at room temperature) to produce a fluid or a paste-like slurry of phytosterol powder in oil. This slurry is optionally homogenized to disaggregate any caked or otherwise aggregated phytosterol microparticles, thereby allowing an increased proportion of the phytosterol microparticles to be uniformly coated with the edible oil.

The slurry is then combined with an edible aqueous medium (e.g., a beverage), and the combination is homogenized to produce a stable dispersion of oil-encapsulated phytosterol microparticles associated with at least one exogenous emulsifier, surfactant or other agent that can stabilize the dispersion of phytosterol microparticles in the beverage. The exogenous emulsifier, surfactant or other agent may be already present as a constituent in the aqueous medium (e.g., a beverage such as cows milk or soy milk), and/or it may be added to the aqueous medium and/or the oil or slurry from either a natural or a synthetic external source.

In contrast, the described methods of Yliruusi, et al. in U.S. Pat. No. 6,531,463 and Perlman, et al. in U.S. Pat. Nos. 6,638,547 and 7,144595, involve dissolving phytosterols in heated vegetable oil (typically at temperatures of 80-140° C.) and then precipitating or recrystallizing the phytosterols with or without adding water. Yliruusi, et al. describe water-induced precipitation of microcrystalline phytosterols from a solution of phytosterols dissolved in hot fat. Perlman et al. describe heating, dissolving and recrystallizing phytosterols in fat without adding water. While the presently described invention also combines phytosterols and fat, (e.g., vegetable oil and microparticulate phytosterols are used to form a slurry), it does not require heating or dissolving the phytosterols in fat.

Furthermore, in contrast with the cited patents of Perlman, et al. which describe fat-based compositions that are substantially free of exogenous solubilizing and dispersing agents for phytosterols, the presently described oil-encapsulated phytosterol microparticles are only useful and dispersible if such exogenous fat/phytosterol-emulsifying and dispersing agents are present. In the case of soy milk and cows' milk, for example, these exogenous solubilizing and dispersing agents are found naturally in the beverage (i.e., the milks) in the forms of lecithin and casein, and become part of the phytosterol composition, to the extent that these agents must bind to the microparticles to achieve and maintain their dispersal. Furthermore, the method of Perlman, et al. involves exposure of the combination of fat and phytosterols to air and heat, i.e., oxidizing conditions, such as during the frying or baking of foods, whereas the present method involves essentially no exposure to air. In fact, when the presently described fat-encapsulated phytosterol microparticles are exposed to heat after dispersal in a beverage, such as during heat milk pasteurization, the microparticles encounter conditions that purge, minimize and/or exclude air or oxygen. Thus, the fat+phytosterol combination used herein is not subjected to the oxidizing conditions of Perlman, et al. Rather, the fat is protected from oxidation, e.g., in the manufacturing and packaging of beverages, in which oxygen is excluded.

In accordance with the description above, in its simplest form, the present invention describes a microparticulate phytosterol powder that is mixed with a vegetable oil, such as high oleic sunflower oil, to form a slurry. Optionally, the slurry or the oil used to form the slurry is supplemented with one or more oil-soluble micronutrients. This slurry is subsequently dispersed into an edible aqueous medium. The edible aqueous medium with the dispersed slurry is homogenized in the presence of an effective amount of emulsifiers, surfactants, and/or other agents that can maintain a stable dispersion of oil-encapsulated phytosterol microparticles in the suspension. In some cases, the exogenous dispersing agents are in the base aqueous medium (e.g., beverage) as either or both of natural emulsifiers or added emulsifiers, surfactants, and/or other agents. The slurry is subsequently admixed into an edible aqueous medium (e.g., a food or beverage product such as soy milk or cows milk), preferably using shear-blending to thoroughly disperse the slurry. The resulting product contains oil-encapsulated phytosterol microparticles that remain uniformly distributed and suspended in the product. The method saves processing time, conserves energy, and saves money compared to many other dispersal methods.

The mixing of the slurry into the edible aqueous medium and the homogenization may be performed in various ways. For example, the slurry may be combined with the aqueous medium and the combination homogenized; in a variant, the slurry may be injected into the aqueous medium immediately prior to or in the course of homogenization. In an alternative, the slurry is first dispersed into the aqueous medium with mixing in which the shear is sufficiently high to achieve dispersion of oil droplets but still leaving larger than desirable fat droplets. The initial dispersion can be homogenized to form the final dispersion in which OEPMs are stably dispersed in the aqueous medium. In implementations in which pasteurization is used, the pasteurization can be performed before or after the homogenization, e.g., for the general procedures indicated above.

The initial observations and evidence that remarkably stable oil-encapsulated phytosterol microparticles are produced, in which the oil remains adhered to the phytosterol particles include the following: High speed micro-centrifugation (one minute @ RCF=14,000×G) of non-ester phytosterol microparticles (obtained from four different commercial sources) suspended only in water results in pellets being formed at the bottom of the centrifuge tubes. This indicates that the phytosterol density is greater than 1.00. The dry powdered phytosterol microparticles were mixed with a 2 to 4-fold excess (by weight) of vegetable oil (density=0.92 versus) to form oil slurries. These slurries were homogenized/dispersed in plain soy milk, and also dispersed in warm water containing an emulsifying agent. Following identical centrifugations, essentially all of the phytosterols were found floating on the surface together with oil, indicating that the phytosterol microparticles had acquired and retained buoyancy, i.e., by remaining encapsulated by the oil. The second line of evidence is optical microscopy (phase contrast at 150× magnification) that revealed oil-encapsulated phytosterols in which the oil portions of the encapsulated microparticles were selectively stained using Sudan Black stain. Further details are provided below.

Slurries of Edible Oil and Phytosterol Microparticles

As described above, the invention relates to methods and compositions for making aqueous beverages and other edible aqueous media (often liquids) that may be directly ingested or may be added to foods or may be precursors to foods (e.g., a yogurt base). The invention also provides methods for making slurries that contain an edible oil and microparticulate phytosterols. Phytosterols as used herein are usually provided as free-flowing dry powders that more specifically include phytosterol microparticles whose weight average diameter is typically ≦25 microns, and preferably ≦10 microns in diameter. The dry powder also commonly contains an anti-caking agent.

Optional excipients such as hydrophilic amorphous silica (silicon dioxide) may be added, e.g., as an anticaking or flow agent, to prevent clumping and caking of the powdered microparticulate phytosterol material during storage (prior to producing the oil slurry), particularly if the powder is exposed to humidity. Other food grade ingredients that are water-dispersible or soluble, such as natural and/or artificial sweeteners, may also be combined into the phytosterol slurry.

The slurry is formed simply by effectively mixing the phytosterol powder into the edible oil. It can be advantageous to homogenize the mixture to reduce clumping of the powder particles, thereby ensuring effective oil encapsulation of a greater proportion of the phytosterol microparticles.

In planning experiments relating to the present invention, Applicant sought a simpler and less costly method for producing water-dispersible non-ester phytosterol powders. Accordingly, Applicant obtained samples of powdered microparticulate non-ester phytosterols from ADM (CardioAid® M, Decatur Ill.) and from Cognis Nutrition and Health (Vegapure® FS, La Grange, Ill.). The diameter of the majority of particles in these phytosterol preparations is ≦10 microns. In addition, three surfactant materials that are suitable for dispersing fatty materials were obtained, i.e., a non-ionic hydrophobic, an anionic, and a mixed surfactant produced by Kerry Bio-Science, Inc. (Rochester, Minn.). These surfactants included:

(a) mono- and diglycerides of stearic acid (Myverol® 18-04 K),

(b) sodium stearoyl lactylate (Admul® SSL 1078 K) and

(c) a binary surfactant as described above (Myvatex® P28 XLK) consisting of a combination of surfactants (a) and (b). The Myvatex P28 binary surfactant is described as containing between 50 and 75% by weight sodium stearoyl lactylate and 25-50% by weight mono and diglycerides of stearic acid. The material is produced by molecular commingling of (a) and (b), such as by co-spraying a melt blend.

In accordance with the description above, an example of an oil slurry blend that may be dispersed in hot or cold aqueous media, such as beverages, containing a natural or synthetic emulsifier, is as follows: One part by weight of microparticulate non-ester sterols, e.g., “CardioAid M” brand micronized free sterols manufactured by Archer Daniels Midland Company (Decatur, Ill.) or “Vegapure FS” brand micronized free sterols manufactured by Cognis Nutrition and Health (La Grange, Ill.) is combined and shear-blended (i.e., homogenized) with approximately 3-4 parts by weight of Clear Valley® brand high oleic sunflower oil produced by Cargill, Inc. (Minneapolis, Minn.) to form an oil slurry. For convenience in production and ease in pump-flow of the slurry, as well as for nutritional fat content purposes, the amount of oil in the slurry can be adjusted. The slurry is subsequently combined and homogenized in an aqueous medium (e.g., a beverage) as broadly defined herein, to achieve dispersal of the oil-encapsulated phytosterol microparticles, e.g., as further described below.

### Dispersal of Slurry as Oil-Encapsulated Phytosterol Microparticles (OEPMs)

As described above, this invention concerns compositions containing dispersions of OEPMs and methods of forming such dispersions. Without being bound or limited by theory, it is believed that dispersal of the slurries, that contain phytosterol microparticles and oil, can occur as emulsifiers, surfactants, or other dispersing agents present in the aqueous liquids described herein or otherwise added, are able to associate with the oil-encapsulated phytosterol microparticle resulting in wetting, and a reduction in the surface tension between the solid microparticle and the surrounding aqueous liquid. Maintenance of the dispersion is facilitated by a reduction of effective density of the phytosterol microparticles due to their association with the oil in the OEPMs. In most cases, the average density of the OEPMs is close that of the base aqueous medium in which they are dispersed. While the OEPM density may be slightly greater than the density of the suspension, in most cases the OEPM density will be slightly less than the base suspension density, while being greater than the density of the edible encapsulating oil. As a result, the OEPMs will have nearly neutral buoyancy, with little tendency to separate from the suspension by either floating to form a surface layer or sinking to form a bottom deposit.

Thus, these novel OEPMs are dispersed and suspended as microparticles in an aqueous liquid environment only with the assistance and binding of exogenous emulsifying and dispersing agents that are excluded from the TRPs described in Perlman, et al., U.S. Pat. No. 6,638,547. Furthermore, unlike the TRPs described previously by Perlman, et al. that are formed under oxidizing conditions, e.g., during baking or frying in the presence of air and oxygen, the presently described OEPMs are essentially free of partially oxidized oil. That is, they are typically formed under essentially anaerobic or oxygen-depleted conditions, even if surrounded by a heated aqueous environment.

Thus, even if the present slurries or OEPMs formed from them are heated such that some or all of the phytosterols melt and recrystallize in the edible oil, the resulting microparticles still differ significantly from the previously described TRPs due to the needed presence of an effective level of exogenous dispersing agent(s) in the present invention.

While emulsifiers, surfactants and/or other dispersing agents are usually provided in the beverage or other aqueous liquid, these agents may also or alternatively be combined into the phytosterol-in-oil slurry from which they are released into the aqueous liquid when the slurry and aqueous liquid are subjected to homogenization. The dispersing agent can include a combination of at least one hydrophobic surfactant, e.g. a non-ionic mono- and diglyceride, and at least one hydrophilic surfactant, e.g., an anionic surfactant. Alternatively, the hydrophobic and hydrophilic components may be conveniently combined into a binary or hybrid molecule in which a single surfactant species exhibits the beneficial properties of both surfactants.

Applicant finds no prior art example of a phytosterol composition, i.e., a non-ester phytosterol composition that is water-dispersible, in which the dispersion of microparticles is formed by producing an oil slurry of microparticulate phytosterols that is combined with an aqueous medium forming a suspension which is homogenized to yield dispersed individual oil-encapsulated phytosterol microparticles. The formation of such a dispersion or “free-floating” OEPMs that have nearly neutral density in an aqueous medium is one more element that distinguishes the present invention from the formation of an amorphous TRP matrix within baked, fried and otherwise heat-processed foods such as fried snack chips as described previously by Perlman, et al. in U.S. Pat. No. 6,638,547. As described in the present invention, phytosterol microparticles are suspended in an oil slurry that is subsequently dispersed into an aqueous emulsifier-containing medium that is then commonly pasteurized, either before or after homogenization. This process can be accomplished simply and cost-effectively using simple blending, homogenization and pasteurization equipment, and commercially available ingredients.

Phytosterols are soluble in edible oils particularly at elevated temperatures. It is estimated that at 80° C. at least 10% by weight of soybean oil-derived phytosterols can be dissolved in a vegetable oil. In U.S. Pat. No. 6,638,547, Applicant describes heating, dissolving, cooling and co-crystallization of phytosterols and edible oils in which oil is intimately associated with phytosterol during crystallization. Applicant has observed that phytosterol solids (both crystalline and amorphous) have a strong affinity for triglyceride-based oils. Thus, for example, after phytosterol microparticles have been coated with oil, these microparticles do not easily release the oil, even when suspended in warm water and subjected to high shear conditions. Selective staining of fat with Sudan Black, and microscopic analysis of phytosterol microparticles shows that a film of fat tends to remain tightly bound to the phytosterol microparticle's surface. It is proposed that this fatty surface film that is established during mixing of the oil slurry described above enhances the association and binding of soluble cholesterol in the GI tract with ingested phytosterol microparticles. Applicant believes this enhanced binding will increase the bioavailability and effectiveness of phytosterols in reducing the LDL cholesterol level in the bloodstream.

As described above in connection with formation of slurries, in planning and development experiments relating to the present invention, Applicant obtained samples of powdered microparticulate non-ester phytosterols from ADM (CardioAid® M, Decatur Ill.) and from Cognis Nutrition and Health (Vegapure® FS, La Grange, Ill.). The diameter of the majority of particles in these phytosterol preparations is ≦10 microns. In addition, three surfactant materials that are suitable for dispersing fatty materials were obtained, i.e., a non-ionic hydrophobic, an anionic, and a mixed surfactant produced by Kerry Bio-Science, Inc. (Rochester, Minn.). These surfactants included:

(d) mono- and diglycerides of stearic acid (Myverol® 18-04 K),

(e) sodium stearoyl lactylate (Admul® SSL 1078 K) and

(f) a binary surfactant as described above (Myvatex® P28 XLK) consisting of a combination of surfactants (a) and (b). The Myvatex P28 binary surfactant is described as containing between 50 and 75% by weight sodium stearoyl lactylate and 25-50% by weight mono and diglycerides of stearic acid. The material is produced by molecular commingling of (a) and (b), such as by co-spraying a melt blend.

After dispersal of microparticles formed from slurries of the preceding materials in a beverage, the microparticles do not show any clumping when viewed under a microscope, i.e., they retain their original size, i.e., 90% of particles ≦10 microns in diameter. This is significant because it helps assure that upon ingestion, these microparticulate phytosterols are well dispersed in aqueous foods, and have maximum surface area and ability to be emulsified in vivo during digestion. These properties also help assure that the phytosterols will have maximum bioavailability in the gastrointestinal tract to compete with, and reduce the absorption of cholesterol into the bloodstream. Again, this discussion is meant to emphasize the advantage of choosing and utilizing phytosterol powders in the recipes described herein with as small a particle size as possible.

The uniqueness of this process is that it is much simpler and more cost-effective than using the prior art solution, melt and/or spray-drying processes to unite phytosterols with surfactants.

For the purpose of maximum biological efficacy of the phytosterols (bioavailability), the microparticulate phytosterol material is preferably provided in as small a microparticle diameter as possible. Optional excipients may also be added to the phytosterol powder to facilitate homogenization of the phytosterol-oil slurry. An exogenous surfactant that is either naturally present in the beverage or other aqueous medium, or that is added to the beverage or medium is advantageously a commercially available surfactant that includes at least one hydrophobic or non-ionic surfactant component, e.g., a monoglyceride, and at least one hydrophilic or ionic surfactant component, e.g., sodium stearoyl lactylate or stearic acid.

One of the important advantages of the present invention over the prior art methods for producing beverage-dispersible phytosterols is the simplicity of the oil slurry dispersal method, resulting in a more cost-effective final product. Typical water-dispersible non-esterified phytosterols are currently being sold in the marketplace at approximately two to three times the price of regular phytosterols (for the same quantity of active phytosterol material). For example the Cognis Corporation currently sells regular non-esterified phytosterol powder (98% actives) in bulk quantities for approximately $15 per kg. Cognis sells the same material in a water-dispersible form that contains only 40% by weight active sterols for approximately the same price per kg. In other words, the phytosterol component of the water-dispersible material is 2.5 times more expensive in the water-dispersible form. By contrast, the oil slurry materials and manufacturing method of the present invention are expected to add only modestly to the cost of the original phytosterols, e.g., an estimated 5%-10% cost increase rather than the 150% price increase mentioned above. Where practicable and beneficial, the beverage is pasteurized to extend the shelf life of the beverage, either before or after homogenization.

It is interesting to compare the present oil slurry method for dispersing a phytosterol powder in an aqueous liquid with the more complex and costly prior art methods for converting waxy sterol particles to water-dispersible or water-soluble particles. These earlier methods either involve forming water-borne surfactant coatings or other emulsifier combinations with the sterol particles (see above, Thakkar at al., Burruano et al. and Ostlund) or involve modifying the overall chemical composition of the sterol particles, e.g., by melt-blending the sterols to make them hydrophilic (see above, Bruce et al. and Stevens et al.). It is remarkable that commercially available unmodified phytosterol particles described herein can be dispersed in a beverage that contains an emulsifying agent by simply forming a vegetable oil-phytosterol slurry and dispersing the slurry into the beverage. All of the ingredients described herein are either food ingredients or comply with the Food and Drug Administration regulations governing direct food additives.

### Examples of Phytosterol Dispersion Tests

Applicant evaluated how readily free phytosterol microparticles (Cognis Inc. Vegapure FS microparticles) could be dispersed into the soy milk described above, as compared to dispersing the same microparticles that had been pre-encapsulated with between a two-fold and four-fold (by weight) excess of vegetable oil. It became immediately evident that the oil-encapsulated microparticles could be dispersed much more readily into the soy milk. While not wishing to be bound by theory, it is suggested that at least two factors contribute to the improved dispersibility of oil-encapsulated phytosterol microparticles. First, the oil surface is probably more receptive than the original sterol surface to coating by the abundance of soluble, surface-active protein and lecithin found in soy milk. In the case of cows' milk, casein and other proteins are effective in emulsifying and suspending fat and oil microdroplets in milk. Second, an edible oil encapsulation coating (density approximately 0.92 g/cm3) reduces the physical density of phytosterol microparticles resulting in particles whose density may more closely approximate the density of skim and regular milk (approximately 1.03 g/cm3).

Thus, in the process of developing the present methods and compositions, and before producing the above-described phytosterol-oil slurries, high speed centrifugation of oil-free non-esterified phytosterol powder samples was utilized to examine relative densities of commercial phytosterol powders. The powder samples were obtained from four different manufacturers (Cardioaid powder from ADM Inc., Decatur, Ill.; Corowise powder from Cargill, Inc., Minneapolis, Minn.; AS-2 tall oil phytosterol powder from Arboris, Inc., Savannah, Ga.; and Vegapure FS powder from Cognis, Inc., LaGrange, Ill.). These four powders were suspended in water and in soy milk at a concentration of 0.5% by weight, subjected to high shear mixing, and centrifuged in a conventional microcentrifuge producing a relative centrifugal force of 14,000×G. All of the powders sedimented through water and soy milk and formed pellets, therefore exhibiting a density somewhat greater than the densities of the respective aqueous media, e.g., greater than about 0.998 g/cm³ for water at 20 degrees C. and greater than about 1.03 g/cm³ for soy milk.

Subsequently, one part by weight of the above-described ADM and Cognis phytosterol powders were thoroughly blended with two parts and with four parts by weight of either a commercial soybean oil or high oleic sunflower oil (Clear Valley brand® provided by Cargill, Inc., Minneapolis, Minn.) to produce uniform powder-in-oil slurries that retained liquid flow, albeit at a reduced rate. These slurries were then blended and dispersed into warm soy milk (Silk brand® plain soy milk) using high shear mixing. Final concentrations of 0.5% by weight of the phytosterols (plus 1.0% and 2.0% by weight of vegetable oil present in the slurries) were thereby added to portions of the soy milk.

Surprisingly, full dispersal of all phytosterol-vegetable oil slurries into the soy milk was achieved with no floating or settling material being visible upon inspection. The dispersal step was later followed by high speed centrifugation (14,000×G) of 1 ml samples of the liquid. Following centrifugation, these samples were compared with centrifuged samples of the same soy milk that had not been supplemented with phytosterols. Only the phytosterol-supplemented samples exhibited a shiny surface film that was absent on the surface of the plain soy milk.

The above-described shiny floating film was stained by adding approximately 0.10 ml of an aqueous ethanol solution of 0.5% Sudan Black stain [0.5% (w/w) in 70% ethanol:30% water] onto the liquid surface inside the microcentrifuge tube. The stained material was removed to a glass slide and examined using phase contrast microscopy at 150× magnification to visualize fat and discriminate fat from phytosterols as previously described by Perlman, et al. in U.S. Pat. Nos. 6,638,547 and 7,144595. Both amorphous and crystalline phytosterol particles surrounded by a moderate excess of stained fat were clearly visible.

This observation is significant because if the phytosterol microparticles in the oil slurry had become separated from oil during their high shear dispersal in the soy milk, they would have been pelleted to the bottom during centrifugation (as are the non-encapsulated phytosterol microparticles). The fact that the phytosterol microparticles were recovered on the surface of the soy milk indicates that their association with vegetable oil is sufficiently strong to provide a substantial oil encapsulation layer with buoyancy sufficient to bring the particles to the soy milk's surface.

The above experiment was repeated, blending one part by weight of the above-described ADM and Cognis phytosterol microparticulate powders with two parts and with four parts by weight of soybean oil to again produce uniform powder-in-oil slurries. Applicant then attempted to disperse these slurries using high shear blending into water (rather than soy milk) at both ambient temperature and at 80° C. While a small amount of the slurry material was dispersed in water, most (>90%) of the material clumped and formed a floating aggregate of oil and phytosterols. Microscopic examination of the suspended material revealed some microdroplets of oil as well as oil-encapsulated phytosterol particles.

However, it is clear that dispersing a slurry of fat-encapsulated phytosterol microparticles in an aqueous liquid is workable only when an adequate amount and type of emulsifier(s) that will stabilize a dispersion of fat microdroplets, or in this case, fat-encapsulated phytosterol microparticles, is present. In many cases, the receiving liquid for the slurry (i.e., the beverage or other aqueous food medium) contains the emulsifier, although the emulsifier can alternatively or in addition be added to the slurry. Homogenized soy milk and cows' milk are known to maintain emulsified fat/oil microdroplets, and clearly contain sufficient amounts of fat-emulsifying proteins and other emulsifiers (e.g., caseins, lecithins) for this purpose. Accordingly, the present invention actually requires producing fat-encapsulated phytosterol microparticles that further acquire or bind to their surface at least one oil-in-water stabilizing emulsifier, e.g., casein and lecithin.

### Physiological Effects of OEPMs

It is suggested that during the process of ingestion and digestion, oil-encapsulated phytosterol microparticles initially enter the GI tract and interact with the chemical environment as a triglyceride rather than a phytosterol, because the phytosterol surface is largely encapsulated by fat. It is believed that the vegetable oil coating surrounding the phytosterol microparticles will promote association with fat-soluble molecules such as cholesterol contained within the bile fluid secreted by the gall bladder. Therefore, the fatty coating should improve the bioavailability of phytosterol microparticles by enhancing the binding to cholesterol.

In other words, Applicant believes that the rigid surface of a phytosterol microparticle would be relatively ineffective compared to the oil surface in attracting and binding cholesterol molecules. In fact, commingling of phytosterol, cholesterol and fat molecules to form mixed micellar structures is believed to be an important step in the biochemical process of eliminating cholesterol from the GI tract.

As a variation of the above, if fat and phytosterols are co-crystallized in OEPMs described above, the intimate association between phytosterol microcrystals and fats should also allow increased binding and molecular mixing of cholesterol and phytosterols in the GI tract. There have been many suggestions in prior art patents including our own (Perlman, et al. in U.S. Pat. No. 6,638,547), that providing dietary fat together with phytosterols can increase phytosterol bioavailability. It is herein suggested that there are at least two components to this enhanced bioavailability. First, consuming a quantity of dietary fat helps induce gall bladder contraction thereby transporting cholesterol-laden bile fluid into the GI tract where phytosterols can combine with cholesterol via mixed micelles to help reduce cholesterol via fecal elimination. Second, both cholesterol and phytosterols are partially fat-soluble at body temperature. Therefore, by forming either fat-encapsulated microparticles of phytosterols or OEPMs as described above, cholesterol that is present in the GI tract (from both the liver and the diet), can be drawn into chemical and micellar association with phytosterols to accelerate fecal elimination of cholesterol.

### Product Applications

Numerous applications exist for the aqueous liquid-dispersible OEPMs in the areas of foods, beverages, and dietary supplements. The present phytosterol-containing oil slurry compositions can be used in a similar manner to other phytosterol compositions, including other water-dispersible phytosterol compositions. One of the major uses for such compositions is to reduce the uptake of dietary cholesterol, e.g., by co-ingestion (usually in the same meal or even in the same food item) of the phytosterol-oil composition with cholesterol-containing food items. Such uses are described in patents cited in the Background, each of which is incorporated herein by reference in its entirety. The present compositions can be used in the same or similar manner to the dry phytosterol compositions described in those patents. Description of such uses will therefore not be repeated herein.

Thus, formulated as a homogenized slurry of phytosterol powder-in-oil (with or without emulsifier included in the slurry), the slurries can be dispersed in beverages and optionally pasteurized as described herein before or after homogenization. Advantageously, pre-dispersed OEPMs can be packaged in pre-measured quantities of the dispersion that are readily opened at the time of use, and added to foods and beverages. Alternatively, the oil slurry of microparticles (with or without emulsifier included) may be packaged in edible capsules for ingestion as dietary supplements to reduce plasma cholesterol levels or in suitable quantities for inclusion in a beverage or other aqueous medium. Alternatively, large quantities of the OEPMs may be used in the commercial production of processed foods and beverages, e.g., soy milk and cows' milk, that require supplementation with phytosterols.

Thus, the present slurries and oil-encapsulated phytosterol microparticles can be used in many different types of beverages and other edible aqueous media (e.g., solutions and/or suspensions and/or emulsions), as well as in a large variety of foods which are prepared using such aqueous solutions and suspensions. For example, these particles may be used in liquid beverages such as water (e.g., plain, flavored, or fortified), soy milk, cows milk, fruit and/or vegetable juices and juice blends (e.g., orange, apple, cranberry, grape, raspberry, blueberry, and carrot juices as well as other fruit and/or vegetable juices and juice blends) steeped or brewed beverages (such as coffee, tea, and herbal teas), milk, dairy products containing significant amounts of water (e.g., yoghurt, cottage cheese, cheese), and in liquids added to apple sauce, canned fruits, foods which are cooked using water or other aqueous liquid as an ingredient (e.g., soups, stews, mashed potatoes, refried beans, pasta, rice, and the like, or can be added to foods which contain significant amounts of water (e.g., raw eggs, which can then be used in essentially any manner for which raw eggs are suitable).

### FDA Regulatory Matters.

The U.S. Food and Drug Administration regulates many surfactants as direct food additives, including the levels of use and types of foods and beverages to which those surfactants may be added. However, many non-ionic surfactants including the mono- and diglyceride esters of fatty acids such as glyceryl monostearate, as used herein, are largely unregulated, and may be used according to good manufacturing practices. Ionic surfactants such as the anionic surfactant, sodium stearoyl lactylate (CAS Reg. No. 25-383-997) is typically limited to between approximately 0.2% and 0.5% of finished food products (see 21CFR Section 172.846) For example, in milk or cream substitutes for coffee beverages, sodium stearoyl lactylate (SSL, as abbreviated herein) is limited to 0.3% by weight of the beverage. For an 8 oz serving, this translates to 0.72 g SSL. If the Myvatex P28 hybrid/mixed surfactant described above contains 50% by weight SSL, then as much as 1.4 g Myvatex P28 may be added to a serving of beverage. The SSL surfactant is approved for use in many other food products, including use in baked products, other dough products, coffee creamer, dehydrated potatoes, snack dips, cheese substitutes, sauces, gravies and any foods containing sauces or gravies, as well as in any prepared mixes for each of the above foods. Since sauces and mixes are very broad categories, and foods that may contain small amounts of sauces is even broader, SSL can properly be added to a wide variety if not limitless range of food products.

While SSL is a preferred anionic surfactant, other similar anionic surfactants may be substituted for SSL in the molecular hybrid anionic/nonionic binary surfactant system described. In many applications the surfactant must be approved by the FDA or other such applicable regulatory authority. For example, sodium stearyl fumarate may be combined with a nonionic surfactant. Similarly, other non-ionic surfactants may be substituted for glyceryl monostearate or glyceryl mono- and distearate, such as glyceryl monopalmitate, glyceryl monooleate and others.

### Definitions

The following definitions of terms are provided to assist the understanding of the reader. For terms that are not defined below, the common definition is assumed as provided in the current edition of Webster's International Dictionary or alternatively, provided in a standard organic chemistry textbook such as Organic Chemistry (5^{th} Edition) by Leroy Wade (Prentice-Hall, Inc). As used in this description and the accompanying claims, the following terms shall have the meanings indicated, unless the context requires otherwise.

The term “edible aqueous medium” or simply “aqueous medium” as used in reference to the present invention is a collective and inclusive term encompassing any aqueous liquid-containing composition that is edible or drinkable (including both suspensions and solutions), including for example an aqueous liquid component of, or aqueous liquid precursor to a processed food product, or a beverage. Thus, vegetable juices, fruit juices, flavored and unflavored waters, microparticulate phytosterol-enriched water used in hydrating or cooking of foods, soy milk, cows milk, and countless other drinkable/edible aqueous liquids are encompassed under the term “edible aqueous medium”. Also included, for example, is the aqueous component of foods which have an aqueous phase in an emulsion such as an oil-in-water emulsion or an edible material having a high viscosity due to high solids content and/or a gel or network structure of solids, including for example, sauces, salad dressings, pre-gelled liquid Jello®, pre-gelled puddings, and pre-fermented dairy yogurt base, among others.

The term “beverage” as used in the present invention is a collective and inclusive term encompassing any aqueous liquid that is intended for or normally considered as drinkable. Thus, vegetable juices, fruit juices, flavored and unflavored waters, soy milk, cows' milk, and other drinkable aqueous liquids are encompassed under the term “beverage”. A “commercial beverage” is one which is commonly sold commercially.

In some instances, the terms “base aqueous medium” and “base beverage” and similar terms are used herein in connection with the present invention. Such terms refer to the aqueous medium or beverage without supplementation with the present OEPMs, and are used as equivalent to the terms “aqueous medium” and “beverage” without the modifier “phytosterol-supplemented” being expressly present or implied by the particular context. The term “phytosterol-supplemented aqueous medium” refers to an aqueous medium that has been supplemented with the present OEPMs; similarly the term “phytosterol-supplemented beverage” and similar terms referring to other food items refer to the beverage or other food item which have been supplemented with the present OEPMs.

The term “slurry” means a mixture or suspension of any finely divided substance(s) in a liquid. While most common slurries elsewhere employ water as a suspending liquid, e.g., plaster of Paris in water and potter's clay in water, the term as used herein refers to phytosterol microparticles suspended in an edible oil.

In connection with the present compositions, the term “stable dispersion” means that at least 90% by weight of oil-encapsulated phytosterol microparticles added to a beverage or other aqueous medium will remain suspended in a suspension stored at 4 degrees C. for at least one day, and preferably for at least 2, 3, 4, 5, or 7 days, or more preferably for the normal lifetime of the beverage. The concentration of non-ester phytosterols included in such a stable dispersion for providing cholesterol reducing benefits currently ranges from approximately 0.4 g to 1 g per serving (e.g., per serving of a beverage).

The term “homogenizing” as used in conjunction with forming a slurry of phytosterol microparticles in oil refers to a mixing, blending, or grinding process that applies shear forces to the phytosterol-oil slurry in such a manner that cohered or agglomerated microparticles of phytosterol become disaggregated and more fully coated with the surrounding oil.

On the other hand, the term “homogenizing” as used in connection with dispersing the above-described slurry into a beverage refers to a process of applying shearing force to the combined beverage and phytosterol in oil combination such microdroplets of phytosterol in oil are formed, e.g., such that small groups or even individual phytosterol microparticles become encapsulated in oil, forming oil-encapsulated phytosterol microparticles. The oil-encapsulated phytosterol microparticles are then stably dispersed within the beverage. It is believed that during homogenization of the slurry into the aqueous medium, both higher shear and larger microparticle size/diameter will favor oil encapsulation of individual phytosterol microparticles, while lower shear and smaller phytosterol microparticle size will allow an increased number of groups of microparticles to be oil-encapsulated and remain cohered (or alternatively allow individual microparticles to become oil-encapsulated and subsequently cohere into groups). Additionally, aggressive emulsifiers/dispersing agents should favor disaggregation of groups of oil-encapsulated microparticles, while less aggressive emulsifiers may allow such groups to remain stable in the aqueous medium. Homogenizing and dispersal can be carried out not only in aqueous beverages such as soy milk and cows milk, but also in a range of aqueous liquid components and liquid precursors of processed food products, e.g., sauces, soups, salad dressings, yogurt dairy base (prior to its fermentation), and the like. In most cases, homogenization is carried out at a temperature ranging from approximately 4° C. to 100° C., depending upon the requirements of the beverage or the food component.

The term “dispersible” refers to the ability of a composition, and in particular, the oil-encapsulated microparticulate phytosterols described herein, to become essentially distributed (preferably substantially uniformly) throughout a quantity, e.g., a serving, of an aqueous medium beverage into which the slurry of phytosterol microparticles in oil is homogenized.

In the context of homogenizing and dispersing the present materials, the term “high shear conditions” is used in a manner consistent with homogenization of milk products, and in particular indicates that the homogenizing conditions are such that milkfat or other fat globules are reduced in size to microdroplets which can be stably dispersed. For example, milkfat droplets that are as commonly as large as 10 microns in diameter can be reduced to microdroplets that are typically smaller than 2 microns in diameter.

In the context of this invention, compositions having viscosities (determined using a viscometer suitable for the particular material and viscosity level) of less than 1000 centipoise shall be considered liquids, compositions having viscosities of 1000 to 25000 shall be considered pourable, and compositions having viscosities above 25000 centipoise shall be considered semi-solid. The compositions may also be thixotropic, in which case the viscosity shall refer to the static viscosity rather than a shear-modified viscosity.

The term “pasteurization” or “pasteurizing” developed in 1864 by Louis Pasteur, refers to a process that either slows or essentially arrests microbial growth in food. Pasteurization involves heating a beverage or food to a defined elevated temperature for a defined period of time (also known as the pasteurization “holding time” or “dwell time”). The process does not kill all pathogenic microorganisms in a food or liquid, but greatly reduces the number of viable pathogens so they are unlikely to cause disease, particularly if a pasteurized product is refrigerated and consumed before its expiration date.

Pasteurization of milk most often, but not always, uses temperatures below boiling since very high temperatures will irreversibly denature or curdle casein proteins after a short period of time. Several protocols for pasteurization that are used today include High Temperature/Short Time or HTST pasteurization, Extended Shelf Life or ESL pasteurization, and Ultra-High Temperature or UHT pasteurization. With regard to milk pasteurization, in the HTST process milk is forced between metal plates or through heated pipes to reach a temperature of 72° C. for 15-20 seconds. For UHT pasteurization, the milk reaches the elevated temperature of 138° C. for approximately 2-5 seconds and becomes essentially sterile. On the other hand, in ESL pasteurization of milk utilizes a microbial filtration step together with a lower temperature than HTST. Milk that is only labeled “pasteurized” is usually treated with the HTST method, whereas milk labeled “ultra-pasteurized” or simply “UHT” has been incubated briefly at the much higher temperature.

Pasteurization methods are standardized and controlled in the U.S. by the U.S. Department of Agriculture (USDA), and in the U.K., by the Food Standards Agency. These agencies require milk to be HTST pasteurized in order to qualify for the “pasteurization” label. Different pasteurization treatment standards apply to different dairy products, depending on the fat content and the intended usage, e.g., cream pasteurization standards differ from those for fluid milk. The HTST pasteurization standard for milk was designed to achieve a 5-log reduction, killing 99.999% of the viable micro-organisms in milk. HTST pasteurization kills almost all yeasts, molds, and common spoilage bacteria, as well as many common pathogenic microorganisms.

For referring to the sizes of particles in this invention, it is recognized that in many cases the particles are substantially non-spherical. Thus, for a particle, the term “diameter” refers to the diameter of a spherical particle having equivalent volume. This can be acceptably approximated by the mean linear dimension of the particle for lines passing through the center of mass of the particle, which itself may be acceptably approximated by taking the mean of the thickness of the particle along 2 orthogonal axes of a coordinate system, with one of the axes aligned with the longest dimension of the particle. Such determination may be made, for example, using a microscope with a suitable length scale. The term “average diameter” refers to the volume medium diameter D(v,0.5), meaning that approximately 50 volume % of the particles have an equivalent spherical diameter that is smaller than the average diameter and approximately 50 volume % of the particles have an equivalent spherical diameter that is greater than the average diameter.

As used in connection with the present invention, the term “phytosterol microparticles” or “microparticulate phytosterols” means the referenced material is in the form of very small solid particles (typically dry or oil-encapsulated particles), e.g., particles having a weight average diameter of between approximately 1 micron and 100 microns. The size and size distribution of the particles may vary widely within this range of sizes. Unless otherwise clearly indicated, reference to phytosterols in the context of the present invention means free phytosterols, i.e., non-esterified phytosterols. Free phytosterols are typically isolated and purified from nature (e.g., from vegetable oils or from tall oils). The qualifying term, “non-ester” is frequently used for additional clarity herein, and means that the phytosterols have not been chemically modified at the hydroxyl site in the molecule by fatty acid esterification as is typically done to render the phytosterols fat-soluble.

Thus, the terms “non-ester phytosterols”, “non-esterified phytosterols”, and “free phytosterols” as used interchangeably herein includes phytosterols, phytostanols and combinations thereof, in which the sterol molecules have not been chemically reacted with, i.e., combined with, a fatty acid via an ester linkage.

The term “binary surfactant” as used herein means the same as “hybrid surfactant.” Briefly, a binary surfactant includes at least one non-ionic (having no ionizing or salt-type groups), predominantly hydrophobic surfactant and also at least one ionic (having one or more ionizing group), predominantly hydrophilic surfactant. The term “surfactant” or surface-active agent as used herein, refers to an agent, usually an organic chemical compound that is at least partially amphiphilic, i.e., typically containing a hydrophobic tail group and hydrophilic polar head group. These properties typically allow solubility of the surfactant in organic solvents as well as in water, and allow the surfactant to promote solubilization or at least dispersal of fatty/waxy materials (such as oil-encapsulated phytosterol microparticles) in beverages and aqueous liquid-containing foods.

In the present context, it is proposed that binary surfactants described herein promote dispersion of hydrophobic oil-encapsulated sterol materials in water by forming micelles in which fatty acid tails can form a hydrophobic core associating with the oil-encapsulated sterol particle while their polar or ionic heads can form an outer shell that maintains favorable contact with water and water-containing foods.

In the present context of a stable dispersion of oil-encapsulated phytosterol microparticles, “exogenous dispersing agent” refers to an emulsifier or surfactant or other dispersing agent which is introduced from a source different from the phytosterol and slurry oil. For example, there is indication herein that emulsifiers or surfactants are present in a number of beverages prepared or obtained from plants and animals (e.g., soy milk and cows' milk). These emulsifiers or surfactants are thus exogenous to the phytosterol microparticles and to the oils used in the slurries. Such emulsifiers or surfactants from the base beverage can, in some cases, supply the emulsifiers or surfactants which act as dispersants in the supplemented beverage. Alternatively (or in addition), exogenous emulsifiers or surfactants may be added to a beverage and/or to the oil or slurry to stabilize the dispersion of oil-encapsulated phytosterol microparticles in that beverage. Without being limited to any particular type of interaction, the association may result from energetically favorable interactions such a charge:charge, charge:polar, and/or polar:polar interactions. For example, surfactant molecules may have ionic interactions with the aqueous beverage and non-ionic interactions with the oil-encapsulated phytosterol microparticles.

The reference to optionally adding one or more “oil-soluble micronutrients” to the oil slurry refers to the optional addition of nutrients required in small quantities throughout life, including oil-soluble vitamins, oil-soluble antioxidants, omega-3 fatty acid enriching oils, other micronutrients and combinations thereof.

The term “monoglyceride” refers to any of the fatty-acid glycerol esters where only one fatty acid group is attached to the glycerol group. Mono- and diglycerides are non-ionic surfactants consisting of a mixture of monoglycerides and diglycerides in which one and two fatty acid groups are attached to the glycerol group; examples are glycerol mono- and distearate and glycerol monolaurate or monopalmitate.

The term “anionic surfactant” refers to a surfactant in which the principal functional group (the “head” of the molecule) is negatively charged, such as stearoyl lactylate (−) with a positively charged sodium counter-ion (a preferred surfactant herein). In general commercial use, anionic surfactants are typically used in laundering, dishwashing and shampoos. The efficacy of these surfactants is generally reduced by the positively charged ions in hard water (calcium and magnesium). Commonly used anionic surfactants include the alkyl sulphates, alkyl ethoxylate sulphates and soaps.

The term “non-ionic surfactant” refers to a surfactant in which the principal functional group is not ionized, i.e., it carries no electrical charge, and in the context of the present invention, is a lipophilic surfactant that exhibits a strong chemical association with phytosterols and oils. Besides the mono- and diglycerides being used herein and used elsewhere in foods, non-ionic surfactants include various ethers of fatty alcohols. In general commerce (laundry products, household cleaners), non-ionic surfactants can be beneficially combined with anionic surfactants because the efficacy of the non-ionics is not compromised by the positively charged ions in hard water.

The term “zwitterionic” or “amphoteric” as used herein refers to surfactants that may carry both a positive and negative charge depending on the pH of the medium. Typically, they may be combined with the other classes of natural and synthetic surfactants. Whereas the positive charge is almost always ammonium, the source of the negative charge may vary (carboxylate, sulphate, sulphonate). These surfactants are frequently used in shampoos, other cosmetic products, and also in hand dishwashing liquids because of their high foaming properties, e.g., alkyl betaine

In the present context, the term “anti-caking agent” refers to an edible inert material that can be added to microparticulate phytosterol powders described herein to reduce caking of the dry powders and/or to promote the dispersibility of the powders in oils and fats used to form slurries. For example, amorphous hydrophilic silicon dioxide such as Cab-O-Sil® M5 or Flo-Gard® AB (described elsewhere herein) may be added at levels up to at least 2% by weight of the slurry composition to remain within the limits prescribed by the U.S. FDA for use as an anti-caking agent direct food additive.

For the present compositions, a cholesterol-lowering amount of phytosterols refers to an amount of phytosterols that significantly reduces the uptake of co-ingested cholesterol for an individual with normal cholesterol uptake. The U.S. FDA presently specifies that an individual should consume at least 400 mg non-ester phytosterols per serving of a food at least twice per day to achieve a meaningful health benefit. However, for individuals who combine the present composition with other cholesterol-lowering pharmacological agents, the cholesterol-lowering amount would typically be smaller, e.g., 2-fold or 4-fold smaller.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the proportions of components used in the present compositions and to the manner in which the compositions are used. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention. Further, specification of a numerical range including values greater than one includes specific description of each integer value within that range.

Thus, additional embodiments are within the scope of the invention and within the following claims.

1. A method of supplementing an edible aqueous medium with phytosterols comprising:
combining a slurry of non-esterified phytosterol microparticles dispersed in edible oil with an aqueous medium to produce a suspension of oil and phytosterol in aqueous medium; and
homogenizing said suspension of oil and phytosterols in aqueous medium, thereby producing a phytosterol-supplemented aqueous medium comprising a stable dispersion of oil-encapsulated phytosterol microparticles (OEPMs) in aqueous medium, wherein said phytosterol-supplemented aqueous medium contains at least one exogenous emulsifier, surfactant or other dispersing agent that stabilizes the dispersion of said oil-encapsulated phytosterol microparticles in said phytosterol-supplemented aqueous medium.

2-42. (canceled)

43. A edible aqueous composition comprising:
a phytosterol-supplemented aqueous medium containing stably dispersed non-esterified phytosterols as a stable dispersion of oil-encapsulated phytosterol microparticles.

44-46. (canceled)
